(19) United States
(12) Patent Application Publication
(10) Pub. No.: US 2005/0028803 A1
(43) Pub. Date: Feb. 10, 2005

(54) Barbeque

(76) Inventor: Meide Jiang, Zhejiang (CN)

Correspondence Address: Neil A. DeChez;Renner, Otto, Boisselle & Sklar, LLP, Nineteenth Floor, 1621 Euclid Avenue, Cleveland, OH, 44115-2191, US

(21) Appl. No.: 10/643,594

(22) Filed: Aug. 19, 2003

(30) Foreign Application Priority Data
Aug. 5, 2003 (CN) 03206863.8

(51) Int. Cl. A47J 37/04

(52) U.S. Cl. 126/25 A; 126/25 AA

(57) ABSTRACT

The invention provides a food processing device designed for a purpose to give a more convenient barbeque, which can fulfil the functions of easily refueling, effectively adjusting the distance between the charcoal grate and the grilled food in the process of grilling, and directly cleaning up the ash at the end of cooking. The fire chamber of the barbeque is a built-in drawer equipped with the coal grate. A window is built in the front of the barbeque body, into which the said drawer fire chamber is inserted. Meanwhile an elevating device, connected to the charcoal grate and fire chamber, is mounted on the coal grate in the drawer.

### TECHNICAL FIELD

The invention belongs to the food processing device, particularly serving as a barbeque for outdoor food grilling.

### BACKGROUND

Limited to the previous technology, the barbeque is usually installed with a fire chamber under a cooking grill that must first be removed before either adding coals or dumping the ash during the time of grilling. For another, lifting up or lowering down the fire chamber is generally fulfilled by pulling the two adjustable hangers mounted at both ends of the fire chamber. Inconveniences occur in respect to the weight of the fire chamber and, user's hands may be subjected to the great heat of the hangers.

So far, no technology offers a barbeque with much convenience in refuelling, adjusting the cooking grill in the fire chamber in cooking and access to the ash after cooking.

### SUMMARY OF INVENTION

Fundamentally, the invention is to attribute to overcome the current weakness of barbeques, thus serving with a barbeque of much convenience that can fulfil the functions of easily refuelling, effectively adjusting the distance between the coal grate and the grilled food in the process of grilling, and directly cleaning up the ash at the end of grilling.

In order to reach the goal above-mentioned, the invention has adopted its own technical solutions:

A barbeque wherein is to be a built-in drawer fire chamber barbeque equipped with the coal grate. A window is built in the front of the barbeque body, into which the said drawer fire chamber is inserted. Meanwhile an elevating device connecting the charcoal grate and the fire chamber is mounted on the coal grate in the drawer. The mounted elevating device includes crankshafts and a revolving handle. There is more than one crankshaft and all of them are pivotally installed on the charcoal grate in a parallel way and both ends of each crankshaft are pivotally attached to the drawer fire chamber. The two ends of at least one crankshaft extend to the outside of the drawer so that the crankshaft can be connected to the revolving handle.

In the construction, a drawer fire chamber has been built into the designed barbeque body, therefore adding and removing coal can be fulfilled easily without moving the cooking grill and the grilled food in the process of cooking. And then, its elevating device mounted in the fire chamber, convenience can be offered in controlling the grilled food to the heating source by means of turning the handle extended outside the unit, thus efficiency can be achieved in terms of food in variety grilled in different temperature as required.

The embodiments of the invention are described in details with, the appended figures as follows:

### DESCRIPTION OF DRAWINGS

FIG. 1: the three-dimensional construction diagram of the barbeque in the invention;

FIG. 2: the sectional perspective view and performing principle of the fire chamber and the elevating device in the invention;

FIG. 3: the sectional magnified view of the part I of FIG. 2 in which the crankshaft is connected to the coal grate pivotally;

FIG. 4: the top view of the drawer built-in fire chamber in the invention;

FIG. 5: the perspective view in the direction of A-A in FIG. 4;

FIG. 6: the perspective view in the direction of B-B in FIG. 4.

### EMBODIMENTS

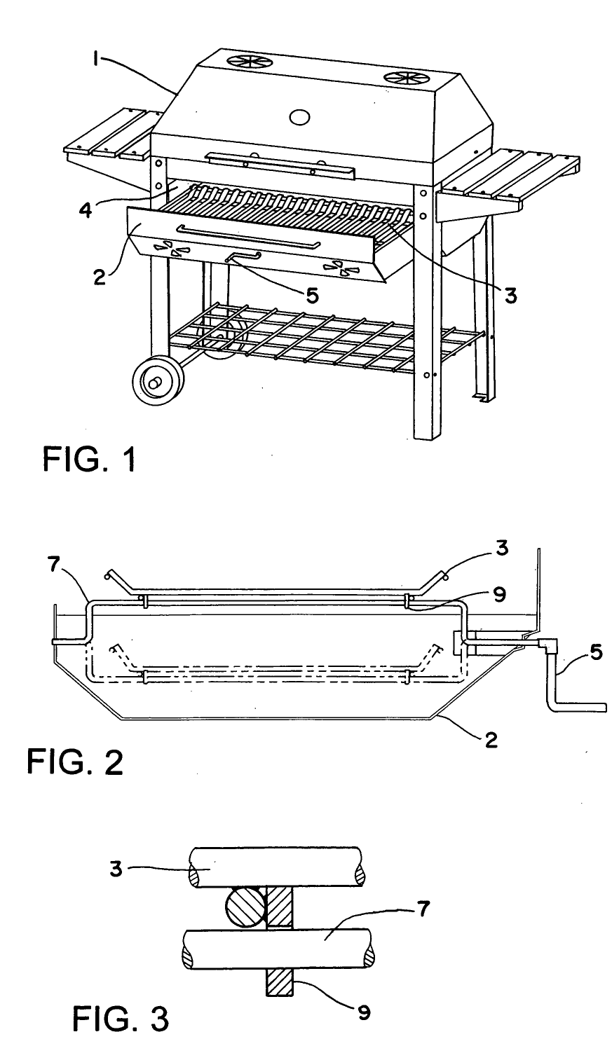

Refer to FIG. 1 and FIG. 2, the designed barbeque is constructed of a grilling body 1 and a built-in drawer fire chamber 2. The built-in drawer fire chamber 2 is a structural drawer installed with a charcoal grate 3 for fuels. A window 4 is built into the front wall of the barbeque body 1, into which the drawer fire chamber 2 is inserted.

Compared to the barbeque without a drawer fire chamber in the previous technology, the invented built-in drawer fire chamber 2 can be pulled out and closed flexibly and easily from the barbeque body so as to add coals or clean up ash without moving away the charcoal grate and grills on it.

Besides, an elevating device is designed in the drawer fire chamber 2, placed between the charcoal grate 3 and the fire chamber 2, functioning as an elevating mechanism connected by the crankshafts.

Refer to FIGS. 2, 4, 5, the elevating device includes a revolving handle 5 and three parallel crankshafts 6,7,8. Respectively both ends of these crankshafts 6,7,8 are pivotally installed in the front and back walls of the fire chamber. As shown in FIG. 3, the bends of the crankshafts are pivotally connected to the charcoal grate 3 by two ringers 9 welded on the bottom of the charcoal grate 3. These ringers 9 serve to let crankshafts go through and rotate. One end of the crankshafts 7 extends outside the drawer fire chamber 2 for the revolving handle to be joined up securely.

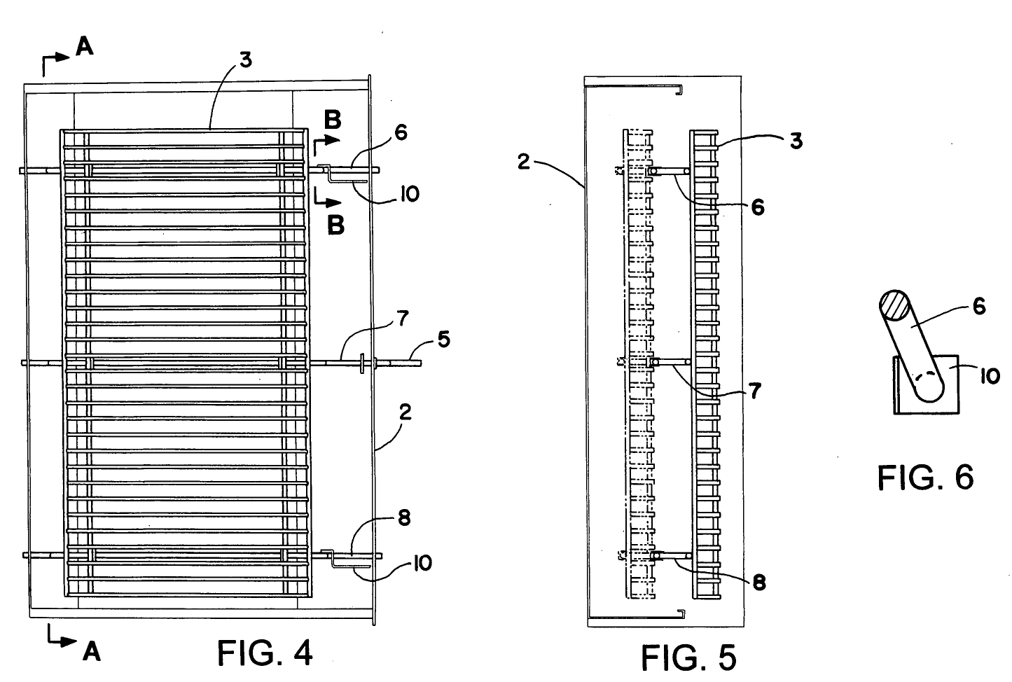

In this way, turning the handle 5, the charcoal grate 3 can be elevated through the linking mechanism constituted by crankshafts 6, 7 and 8 pivotally connected to it. Refer to FIG. 4, 6, to locate the crankshafts 6,8 when reaching the top height, position component 10 is provided on the front wall of the drawer fire chamber 2 customized to the position of the crankshaft 6,8 respectively, which allows the crankshafts 6,8 lean against the position component 10 whenever rotating to the top end to rest.

Compared to the old method of equipping with hooks on both ends of the fire chamber in the barbeque to elevate it by pulling the hooks, the current invention simply acquires the effect by turning the handle 5 to bring the crankshafts 6,8 to rotate but without lifting the entire fire chamber (In FIG. 2, the solid line and dashed line respectively indicates the top height and the lowest position the crankshaft 7 and the charcoal grate 3 turn to). Therefore, it offers much more conveniences to adjust the grilled food and the heat source for food in variety without any occurrence of scalding hands.

1. A barbeque, wherein
the fire chamber of the barbeque is a built-in drawer equipped with the coal grate, a window is built in the front of the barbeque body, into which the said drawer fire chamber is inserted. Meanwhile an elevating device connecting the charcoal grate and the fire chamber is mounted on the coal grate in the drawer.

2. A barbeque according to claim 1, wherein
the mounted elevating device includes crankshafts and a revolving handle, there is more than one crankshaft and all of them are pivotally installed on the charcoal grate in a parallel way and both ends of each crankshaft are pivotally attached to the drawer fire chamber, the two ends of at least one crankshaft extend to the outside of the drawer so that the crankshaft can be connected to the revolving handle.
